(19) United States
(12) Patent Application Publication
(10) Pub. No.: US 2007/0180459 A1
(43) Pub. Date: Aug. 2, 2007

(54) METHODS AND APPARATUS TO IDENTIFY VIEWING INFORMATION

(76) Inventors: Craig Smithpeters, Roswell, GA (US); Arun Ramaswamy, Tampa, FL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/608,637

(22) Filed: Dec. 8, 2006

Related U.S. Application Data
(63) Continuation of application No. PCT/US05/20027, filed on Jun. 8, 2005.
(60) Provisional application No. 60/578,343, filed on Jun. 9, 2004.

(51) Int. Cl. H04N 7/173; H04N 7/16; H04N 7/00; H04N 11/00; H04H 9/00

(52) U.S. Cl. 725/19; 725/135; 725/136; 348/460; 725/25; 725/102; 725/133; 725/153

(57) ABSTRACT

Methods and apparatus to identify viewing information are disclosed. In an example method, at least one media signal delivered by a content terminal such as a set top box to a media presentation device such as a television is detected. The media signal includes pixel information that is used to generate one or more images on the television. Encoded viewing information generated at a media consumption site is extracted from the pixel information by a metering device, decoded by the metering device, and then transmitted to a data collection facility for processing.

### RELATED APPLICATION

This patent is a continuation of International Application Serial Number PCT/US2005/020027, entitled “Methods and Apparatus to Identify Viewing Information,” and filed on Jun. 8, 2005. This patent also claims priority from U.S. Provisional Application Ser. No. 60/578,343, entitled “Methods and Apparatus to Identify Viewing Information” and filed on Jun. 9, 2004. International Application Serial Number PCT/US2005/020027 and U.S. Provisional Application Ser. No. 60/578,343 are hereby incorporated by reference in their entireties.

### TECHNICAL FIELD

The present disclosure relates generally to audience measurements, and more particularly, to methods and apparatus to identify viewing information.

### BACKGROUND

Determining the size and demographics of a viewing audience helps television program producers improve their television programming and determine a price for advertising during such programming. In addition, accurate television viewing demographics allows advertisers to target certain sizes and types of audiences.

To collect demographic information, an audience measurement company may enlist a number of television viewers or audience members to cooperate in an audience measurement study for a predefined length of time. The viewing habits of these enlisted viewers or audience members, as well as demographic data for these enlisted viewers, is collected and used to statistically determine the size and demographics of a television viewing audience. In some cases, automatic measurement systems may be supplemented with survey information recorded manually by the audience members.

The process of enlisting and retaining participants for purposes of audience measurement can be a difficult and costly aspect of the audience measurement process. For example, participants must be carefully selected and screened for particular characteristics so that the population of participants is representative of the overall viewing population. In addition, the participants must be willing to perform specific tasks that enable the collection of the data, and the selected participants must be diligent about performing these specific tasks so that the audience measurement data accurately reflects their viewing habits. Thus, audience measurement companies are researching different ways to automatically collect viewing data to increase accuracy of the statistics and provide greater convenience for the survey participants.

Some interactive television (iTV) platforms enable an iTV application to determine viewing information such as, for example, the currently tuned channel or service, and/or to receive an event when a tuning operation occurs. However, such iTV platforms often have limited capabilities to transmit such viewing information to another device or location (e.g., a data collection facility). For example, existing iTV platforms fail to provide a standardized method for transmitting information via input/output (I/O) ports such as, for example, RS-232 or IEEE-1394 compliant ports that may be coupled to metering devices. Some iTV service providers may provide a return channel or back channel via an in-band or out-band channel for two-way communication with another device and/or server. However, communication from the iTV platforms via the return/back channel may be limited by the discretion of the iTV service providers. As a result, audience measurement companies may have difficulty collecting viewing data from existing iTV platforms.

### BRIEF DESCRIPTION OF THE DRAWINGS

FIG. 1 is a block diagram representation of an example media broadcast and metering system.

FIG. 2 is a block diagram representation of an example video output monitoring system.

FIG. 3 is an enlarged representation of the example display of the example video output monitoring system of FIG. 2.

FIG. 4 is a representation of an example viewing information index that may be used to implement the example video output monitoring system of FIG. 2

FIG. 5 depicts one manner in which an on-screen pixel grid associated with the example video output monitoring system of FIG. 2 may be configured.

FIG. 6 depicts one manner in which the example on-screen pixel grid of FIG. 5 may be configured to convey viewing information.

FIG. 7 depicts another manner in which an on-screen pixel grid associated with the example video output monitoring system of FIG. 2 may be configured to convey viewing information.

FIG. 8 depicts one manner in which the example on-screen pixel grid of FIG. 7 may be arranged in a non-contiguous configuration.

FIG. 9 is a flow diagram representation of one manner in which the example video output monitoring system of FIG. 2 may be configured to identify viewing information.

FIG. 10 is a block diagram representation of an example processor system that may be used to implement the example video output monitoring system of FIG. 2.

### DETAILED DESCRIPTION

Although the following discloses example systems including, among other components, software executed on hardware, it should be noted that such systems are merely illustrative and should not be considered as limiting. For example, it is contemplated that any or all of the disclosed hardware and software components could be embodied exclusively in dedicated hardware, exclusively in firmware, exclusively in software or in some combination of hardware, firmware, and/or software.

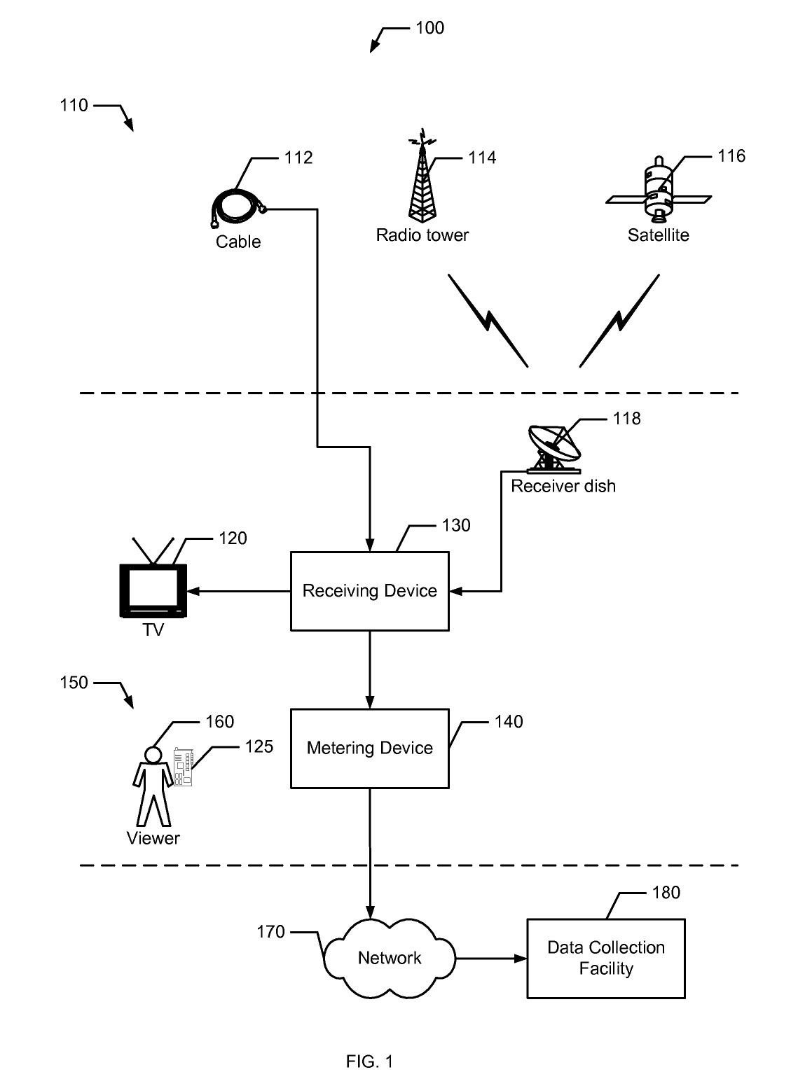

In the example of FIG. 1, an example broadcast system 100 including a service provider 110, a television 120, a remote control device 125, and a receiving device such as a set top box (STB) or a multimedia personal computer (PC) 130 is metered using an audience measurement system. The components of the system 100 may be coupled in any well-known manner. In the illustrated example, the television 120 is positioned in a viewing area 150 located within a house occupied by one or more people, referred to as household members 160, all of whom may have agreed to participate in an audience measurement research study. The viewing area 150 includes the area in which the television 120 is located and from which the television 120 may be viewed by the one or more household members 160 located in the viewing area 150. In the illustrated example, a metering device 140 is configured to identify viewing information based on video output signals conveyed between the receiving device 130 to the television 120. The metering device 140 provides this viewing information as well as other tuning and/or demographic data via a network 170 to a data collection facility 180. The network 170 may be implemented using any desired combination of hardwired and wireless communication links including, for example, the Internet, an Ethernet connection, a digital subscriber line (DSL), a telephone line, a cellular telephone system, a coaxial cable, etc. The data collection facility 180 may be configured to process and/or store data received from the metering device 140 to produce ratings data and/or any other data related to media consumption by the household members 160 and/or other participants (not shown).

The service provider 110 may be implemented by any service provider such as, for example, a cable television service provider 112, a radio frequency (RF) television service provider 114, and/or a satellite television service provider 116. The television 120 receives a plurality of television signals transmitted via a plurality of channels by the service provider 110 and may be adapted to process and display television signals provided in any format such as a National Television Standards Committee (NTSC) television signal format, a high definition television (HDTV) signal format, an Advanced Television Systems Committee (ATSC) television signal format, a phase alteration line (PAL) television signal format, a digital video broadcasting (DVB) television signal format, an Association of Radio Industries and Businesses (ARIB) television signal format, etc.

The user-operated remote control device 125 enables a user (e.g., the household member 160) to cause the television 120 to tune to and receive signals transmitted on a desired channel, and to cause the television 120 to process and present the programming content contained in the signals transmitted on the desired channel. The processing performed by the television 120 may include, for example, extracting a video and/or an audio component delivered via the received signal, causing the video component to be displayed on a screen/display associated with the television 120, and causing the audio component to be emitted by speakers associated with the television 120. The programming content contained in the television signal may include, for example, a television program, a movie, a website, an advertisement, a video game, and/or a preview of other programming content that is currently offered or that will be offered in the future by the service provider 110.

While the components shown in FIG. 1 are depicted as separate structures within the broadcast system 100, the functions performed by some of these structures may be integrated within a single unit or may be implemented using two or more separate components. For example, although the television 120 and the receiving device 130 are depicted as separate structures, persons of ordinary skill in the art will readily appreciate that the television 120 and the receiving device 130 may be integrated into a single unit (e.g., an integrated digital TV set). In another example, the television 120, the receiving device 130, and/or the metering device 140 may also be integrated into a single unit.

As described in greater detail below, the receiving device 130 may be based on an interactive television (iTV) platform such as, for example, OpenCable™ Applications Platform (OCAP™), Multimedia Home Platform (MHP), Digital TV Applications Software Environment (DASE) platform, Association of Radio Industries and Businesses (ARIB) platform, etc. Known iTV platforms may collect viewing information including a tuned channel and/or an event when a tuning operation occurs. However, most iTV platforms have limited capabilities or none at all to transmit collected viewing information to another device and/or location (e.g., a data collection facility such as the facility 180 of FIG. 1). Further, although some iTV platforms may support two-way communication via a return channel or a back channel, access to the return channel or the back channel by third parties (e.g., a media monitoring or ratings company) may be limited by the iTV service providers.

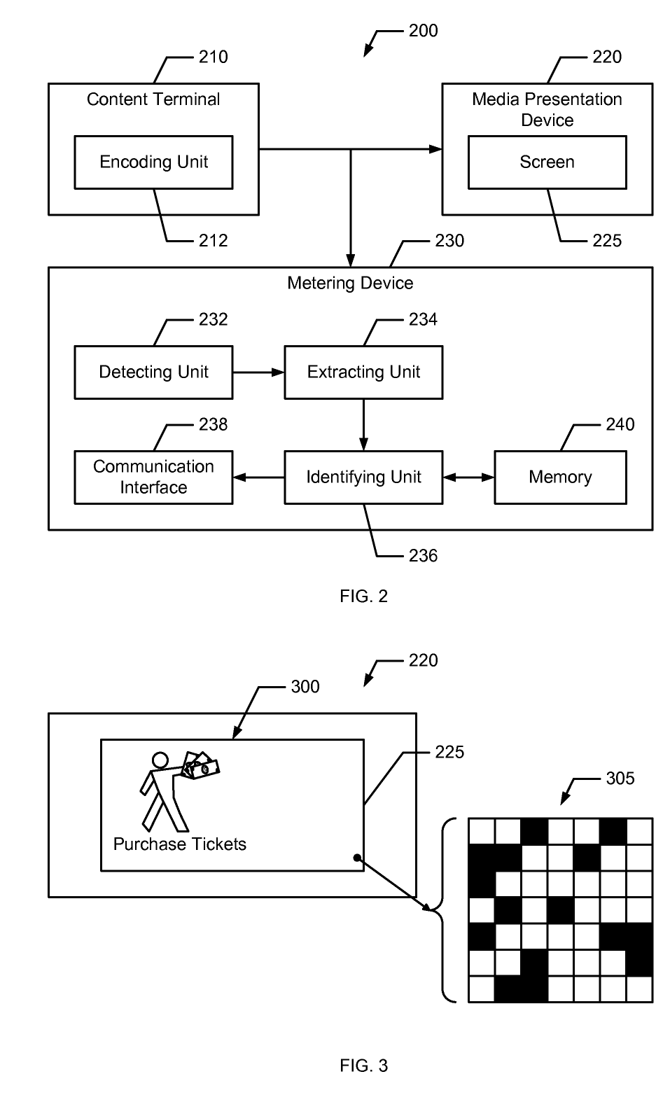

In general, the example video output monitoring system described herein (e.g., the video output monitoring system 200 of FIG. 2) may be implemented to identify viewing information associated with an individual (e.g., the household member 160). As noted above, for example, the individual may use the user-operated remote control device 125 (FIG. 1) to cause the television 120 to tune to and receive signals transmitted on a desired channel. The individual may also input demographic information such as age, gender, race, income, etc. via the remote control device 125. In this manner, the example video output monitoring system described herein may be configured to encode the tuning and/or demographic information into pixel information that is used to generate one or more images, which are substantially visually imperceptible to the individual and/or other viewers, on a media presentation device (e.g., a television) at a media consumption site. The encoded tuning and/or demographic information is extracted and decoded from the pixel information by a metering device and transmitted to a data collection facility for processing. In another example, the individual may place a purchase order of a product such as movie tickets with an iTV service provider via a return channel or a back channel. The video output monitoring system may be configured to encode the purchase order information into pixel information that is used to generate one or more images, which again are substantially visually imperceptible by the individual and/or other viewers, on the television. As a result, the encoded tuning information can be extracted and decoded from the pixel information by the metering device without having to access the return/back channel controlled by the iTV service provider.

In the example of FIG. 2, the illustrated video output monitoring system 200 includes a content terminal 210 (e.g., the receiving device 130 of FIG. 1), a media presentation device 220 (e.g., the television 120 of FIG. 1), and a metering device 230 (e.g., the metering device 140 of FIG. 1). The video output monitoring system 200 may be located in a media consumption site where household members (e.g., the household members 160 of FIG. 1) consume media content. In general, the content terminal 210 is configured to transmit a video output signal associated with programming content to the media presentation device 220 and the metering device 230. For example, the content terminal 210 may be an iTV terminal, the receiving device 130 of FIG. 1, or other devices that process programming content for display or consumption. Accordingly, the video output signal may be associated with an iTV application that enables, for example, selecting a video program to view from a central bank of programs, playing video games, banking and/or shopping from home, and/or voting or providing other user feedback via the media presentation device 220. For example, a viewer may purchase tickets for an upcoming sporting event and/or other events during a broadcast of a current event. The viewer may also order food from a restaurant during a commercial for that restaurant. In another example, the viewer may enter a zip code and/or a city name to receive local/regional/national weather and/or traffic information.

Based on an iTV platform mentioned above, the content terminal 210 may generate pixel information to activate or deactivate pixels associated with a screen 225 of the media presentation device 220 (e.g., the television 120 of FIG. 1 and/or other video output devices such as a monitor) to cause the generation of one or more images on the screen 225 of the media presentation device 220. In particular, the video output signal of the content terminal 210 includes pixel information that is used to generate one or more images associated with the programming content (e.g., an iTV application) on the screen 225. For example, the pixel information may include video information and encoded viewing information. As described in detail below, the video information includes pixel information that represents one or more images associated with the programming content, whereas the encoded viewing information includes viewing information that has been encoded into portions of the video output signal that would otherwise be used for pixels associated with viewable programming content, a vertical blanking interval, a blank frame, etc.

The content terminal 210 includes an encoding unit 212. Based on the interaction with the viewer, the encoding unit 212 may encode the viewing information into the pixel information of the video output signal (i.e., the encoded viewing information) using, for example, the American Standard Code for Information Interchange (ASCII) coding algorithm, a Huffman-based coding algorithm, a binary coding algorithm, and/or any other suitable coding algorithm(s). The viewing information identifies tuning and/or demographic information associated with the audience of programming content currently being consumed (e.g., viewed, listened to, etc.) via the media presentation device 220. For example, the viewing information may include a status identifier associated with a household member 160, a channel identifier associated with a tuned channel, and/or a timestamp associated with the time at which particular content is displayed. The status identifier may, for example, indicate whether the household member 160 is logged in or logged out. The channel identifier indicates a tuned channel that is currently being displayed by the media presentation device 220. The timestamp may indicate a time at which the household member 160 logged in or logged out and/or a time at which a tuning event occurred. For example, the timestamp may indicate a time at which the household member 160 tuned to a channel via the content terminal 210. The viewing information may also include information indicative of user input associated with the iTV application such as, for example, the number of tickets purchased for an event.

As described in detail below, the metering device 230 may extract the encoded viewing information from the pixel information of the video output signal to identify the viewing information. In other words, certain predetermined pixels of the video output signal from the content terminal 210 are used for the encoded viewing information rather than video information associated with program content or other video information. However, because relatively few pixels are used to convey the encoded viewing information, the disturbance to the video images associated with content being viewed is substantially imperceptible to an audience member. The metering device 230 may be configured to detect and decode the encoded viewing information and to transmit the decoded viewing information to the data collection facility 180 for processing to produce ratings data without having to use a return/back channel controlled by an iTV service provider.

In the example of FIG. 3, the screen 225 displays one or more images associated with programming content 300 (e.g., a request or offer to purchase tickets to a game) based on the pixel information supplied by the content terminal 210 (FIG. 2). In addition, as noted above, the viewing information may be encoded into the pixel information. For example, the encoded viewing information may utilize a predefined set or group of pixels 305 located in predefined display locations to represent each of the tuned channel, household member status or tuning events, and/or the timestamp. The total number of pixels indicative of the tuned channel, the household member status or tuning events, and/or the timestamp is typically small compared to the total number of pixels available on the screen 225. As a result, the encoded viewing information does not affect the displayed programming content image in a manner that is not perceptible to the viewers. In other words, the disturbance to the image(s) associated with the programming content is substantially imperceptible to the viewers. According to the NTSC standard, for example, the screen 225 may have a resolution of 720×576 pixels for a total of 414,720 pixels.

As illustrated in FIG. 3, nine pixels may be used to represent the tuned channel for channel numbers ranging from 1 to 511, four pixels may be used to represent the status or tuning events associated with or initiated by eight household members, and thirty-two pixels may be used to represent a timestamp in Universal Time Coordinated (UTC) format. Thus, a total number of forty-five pixels may be used to represent the tuned channel, the household member status or tuning events, and the timestamp information out of the 414,720 available pixels. In another example, ten pixels may be used to represent a tuned channel number ranging from 1 to 1023, five pixels may be used to represent the status or tuning events associated with or initiated by sixteen household members, and thirty-two pixels may be used to represent a timestamp in UTC format (i.e., a total number of forty-seven pixels may be used out of the 414,720 available pixels).

While the example set or group of pixels 305 used to convey viewing information is depicted as a contiguous block of pixels, other sets or groups of pixels may be used instead. For example, multiple smaller contiguous blocks of pixels may be used, the set or group of pixels containing the viewing information may be composed of individuals pixels distributed evenly or unevenly over the programming content 300, etc. In the examples described above, the encoded viewing information may be configured in a symmetrical format (e.g., 7×7) or an asymmetrical format (e.g., 2×25).

Additionally or alternatively, the number and location of pixels containing viewing information may vary over time based on, for example, the quantity of viewing information to be conveyed. In some applications, the number and arrangement of pixels used to convey viewing information may be varied to minimize distortion of the viewable program content. For example, pixels within large uniform regions of viewable content may be preferred to regions containing small image details. Further, the set or group of pixels may be distributed in different areas of the screen 225 at different times. In addition to the tuned channel, the household member status or tuning events, and/or the timestamp, the set or group of pixels may convey other tuning and/or demographic information such as a response by a household member to an inquiry (e.g., a survey), etc.

The encoded viewing information may be visible on the screen 225 for a short period of time. For example, the viewing information may be encoded in blank frames as described in, for example, International PCT Patent Application No. PCT/US04/09910, entitled “Methods and Apparatus to Detect a Commercial in a Video Broadcast Signal,” the entire disclosure of which is hereby incorporated by reference in its entirety. Additionally or alternatively, the viewing information may be encoded in vertical blanking intervals (VBI's) of the video output signal so that the encoded viewing information is not displayed on the screen 225.

Referring back to FIG. 2, the metering device 230 includes a detecting unit 232, an extracting unit 234, an identifying unit 236, a communication interface 238, and a memory 240. In general, the detecting unit 232 is coupled to the content terminal 210 (e.g., via an input/output port) to monitor and receive the same video output signal as the media presentation device 220. The extracting unit 234 is configured to detect and extract the encoded viewing information from the pixel information of the video output signal based on one or more pixel characteristics. In this manner, the identifying unit 236 may identify the viewing information associated with programming content based the encoded viewing information. The identifying unit 236 may be configured to identify viewing information associated with an iTV application such as, for example, the tuned channel, the household member status or tuning events, and/or the timestamp. The memory 240 may store an index, a table, a list, or any other suitable data structures to map the encoded viewing information to the viewing information.

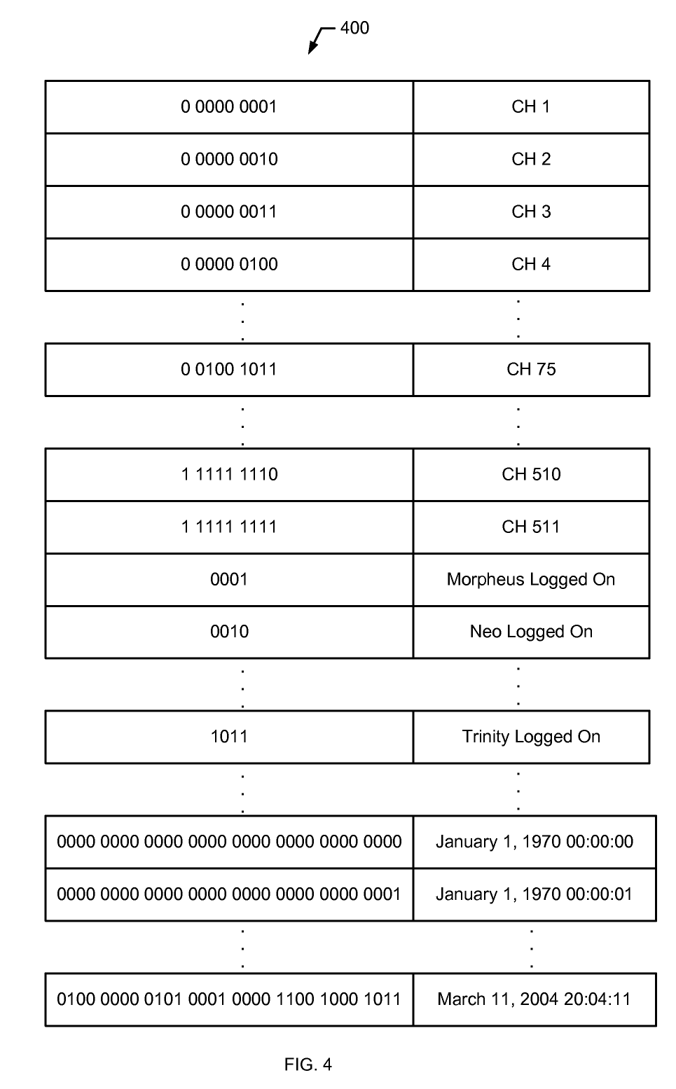

As noted above, the viewing information may be encoded using, for example, a conventional binary coding algorithm (e.g., unsigned integer most significant bit first (UIMSBF) notation). Turning to FIG. 4, for example, an example viewing information index 400 may include a plurality of binary codes corresponding to viewing information. In the example index 400, each of the plurality of binary codes corresponds to a tuned channel, a household member status or a tuning event, or a timestamp. Following an example format mentioned above, nine pixels may be used to represent the tuned channel for channel numbers ranging from 1 to 511, four pixels may be used to represent the status or tuning events associated with eight household members, and thirty-two pixels may be used to represent the timestamp in Universal Time Coordinated (UTC) format. Based on UIMSBF notation, for example, a nine-bit binary code of “0 0100 1011” may represent a tuned channel number 75, and a four-bit binary code of “0010” may represent when a particular audience member (e.g., Neo) is logged on. The timestamp is converted to a number of seconds from Jan. 1, 1970 because the timestamp is compliant with the UTC format. For example, Mar. 11, 2004 at 8:04 pm and eleven seconds corresponds to 1,079,053,451 seconds. Accordingly, a thirty two-bit binary code of “0100 0000 0101 0001 0000 1100 1000 1011” represents Mar. 11, 2004 20:04:11. As described in detail below, each bit of a binary code corresponds to one pixel of the set or group of pixels used to convey the viewing information (e.g., the set 305 of FIG. 3).

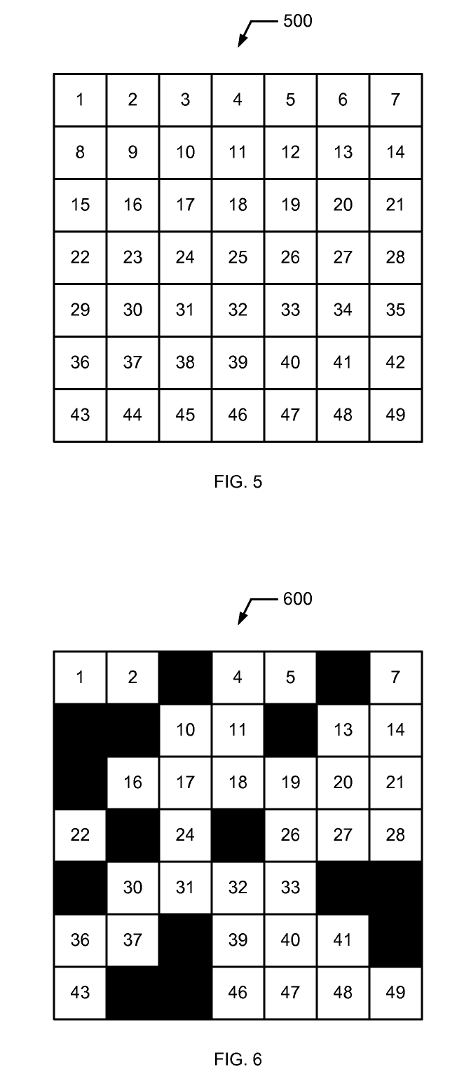

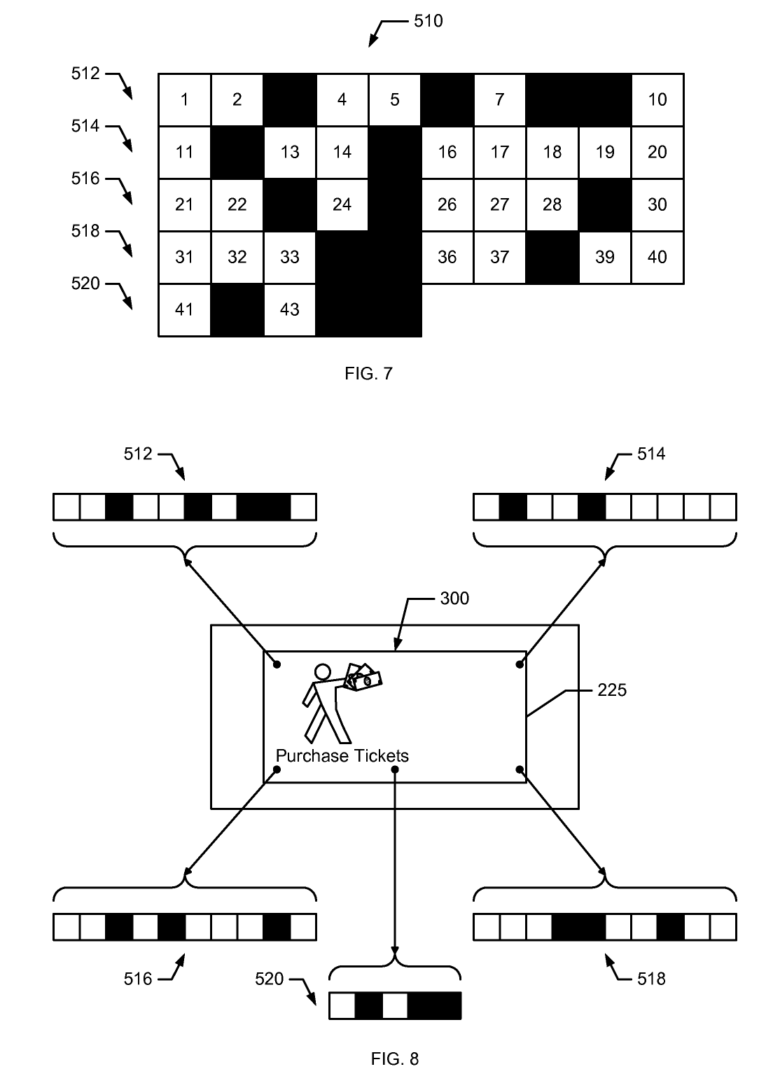

Referring to FIG. 5, an example on-screen pixel grid 500 may represent a set or group of pixels used to convey viewing information. In particular, the on-screen pixel grid 500 may include forty-nine pixels (i.e., pixels 1-49) in a symmetrical configuration of 7×7 pixels. The tuned channel may be represented by pixels 1 through 9 (i.e., the channel pixel set). The household member status or tuning events may be represented by pixels 10 through 13 (i.e., the status pixel set). The timestamp may be represented by pixels 14 through 45 (i.e., the timestamp pixel set). For simplicity, the on-screen pixel grid 500 is described as having a symmetrical configuration of 7×7 pixels. In this example, pixels 46 through 49 are not used to convey viewing information. Thus, the on-screen pixel grid 500 may be arranged in other configurations such as an asymmetrical configuration, a non-contiguous configuration, etc. and/or vary in size as described in detail below so that the on-screen pixel grid 500 may include a quantity of pixels to convey viewing information without occupying extraneous pixel(s). For example, the on-screen pixel grid 500 may include a total of forty-five pixels instead of forty-nine pixels (e.g., the on-screen pixel grid 510 of FIG. 7).

A red-green-blue (RGB) value or color may be used to indicate an active pixel or a binary value of one. For example, solid black may be used to indicate an active pixel or a binary value of one. Accordingly, any color other than solid black may be used to indicate an inactive pixel or a binary value of zero. In the example of FIG. 6, the on-screen pixel grid 600 represents the on-screen pixel grid 500 when viewing information is conveyed in the set or group of pixels 305. In this manner, pixels 3, 6, 8, and 9 of the channel pixel set in the on-screen pixel grid 600 are solid black to represent a tuned channel number 75. Pixel 12 of the status pixel set is solid black to represent that a particular audience member (e.g., Neo) is logged on. Pixels 15, 23, 25, 29, 34, 35 38, 42, 44 and 45 of the timestamp pixel set are solid black to represent Mar. 11, 2004 at 8:04 pm and 11 seconds.

While the methods and apparatus described herein are particularly well suited to represent the encoded viewing information based on chrominance (i.e., color), persons of ordinary skill in the art will readily appreciate that other pixel characteristics such as luminance (i.e., intensity) may be used to represent the encoded viewing information. For example, an intensity greater than a threshold may be indicative of an active pixel or a binary value of one, and an intensity less than or equal to the threshold may be indicative of an inactive pixel or a binary value of zero.

Although the example on-screen pixel grids 500 and 600 are depicted as symmetrical configurations, the on-screen pixel grids 500 and 600 may be arranged in other configurations such as an asymmetrical configuration, a non-contiguous configuration (e.g., individuals pixels distributed evenly or unevenly over the programming content), etc. In the example described in conjunction with FIGS. 5 and 6, a total of forty-five pixels are used to convey the viewing information (i.e., nine pixels to represent the tuned channel, four pixels to represent the status or tuning events associated with eight household members, and thirty-two pixels to represent the timestamp). In the example of FIG. 7, the on-screen pixel grid 510 may be an asymmetrical configuration including four rows of ten pixels, generally shown as 512, 514, 516, and 518, and one row of five pixels 520 for a total of forty-five pixels to convey the viewing information. Further, the on-screen pixel grid 510 may be arranged in a non-contiguous configuration. Referring to FIG. 8, for example, the on-screen pixel grid 510 may be arranged in a non-contiguous configuration with each of the four rows of ten pixels located proximate to one of the four corners of the screen 225 and the one row of five pixels located proximate to the center-bottom portion of the screen 225.

In addition to being arranged in different configurations, the on-screen pixel grids 500 and 600 may vary in size based on the number of pixels used to represent the binary codes associated with the tuned channel, the household member status or tuning events, and the timestamp. For example, ten pixels may be used to represent the tuned channel number for channel numbers ranging from 1 to 1023, five pixels may be used to represent the status or tuning events associated with sixteen household members, and thirty-two pixels may be used to represent the timestamp in UTC format. Accordingly, a set or group of forty-seven pixels may be used to convey the viewing information.

Further, while the methods and apparatus described herein are particularly well suited to use binary codes to represent the encoded viewing information, persons of ordinary skill in the art will readily appreciate that other non-binary codes may be used to represent the encoded viewing information. For example, hexadecimal codes may be used to represent the encoded viewing information with different pixel intensity corresponding to different hexadecimal values (e.g., zero through F). In this manner, the darkest intensity of a color may be used to indicate a hexadecimal value of F, and the lightest intensity of a color may be used to indicate a hexadecimal value of zero. As the hexadecimal value increases from zero to F (e.g., 1, 2, 3, . . . A, B, C, . . . ), the pixel intensity becomes darker and darker. For example, the pixel intensity associated with the hexadecimal value of 3 is less than the pixel intensity associated with the hexadecimal value of 4. In another example, the pixel intensity associated with the hexadecimal value B is less than the pixel intensity associated with the hexadecimal value of C.

Referring back to FIGS. 1 and 2, the communication interface 238 is configured to transmit the viewing information to, for example, the data collection facility 180 via the network 170. Accordingly, the communication interface 238 transmits the viewing information identified by the identifying device 236 to the data collection facility 180. As a result, ratings data may be produced based on the viewing information.

While the components shown in FIG. 2 are depicted as separate structures within the video output monitoring system 100, the functions performed by some of these structures may be integrated within a single unit or may be implemented using two or more separate components. For example, although the content terminal 210 and the media presentation device 220 are depicted as separate structures, persons of ordinary skill in the art will readily appreciate that the content terminal 210 and the media presentation device 220 may be integrated into a single unit. In another example, the media presentation device 220 and the metering device 230 may also be integrated into a single unit. In fact, the content terminal 210, the media presentation device 220, and the metering device 230 may be integrated into a single unit as well.

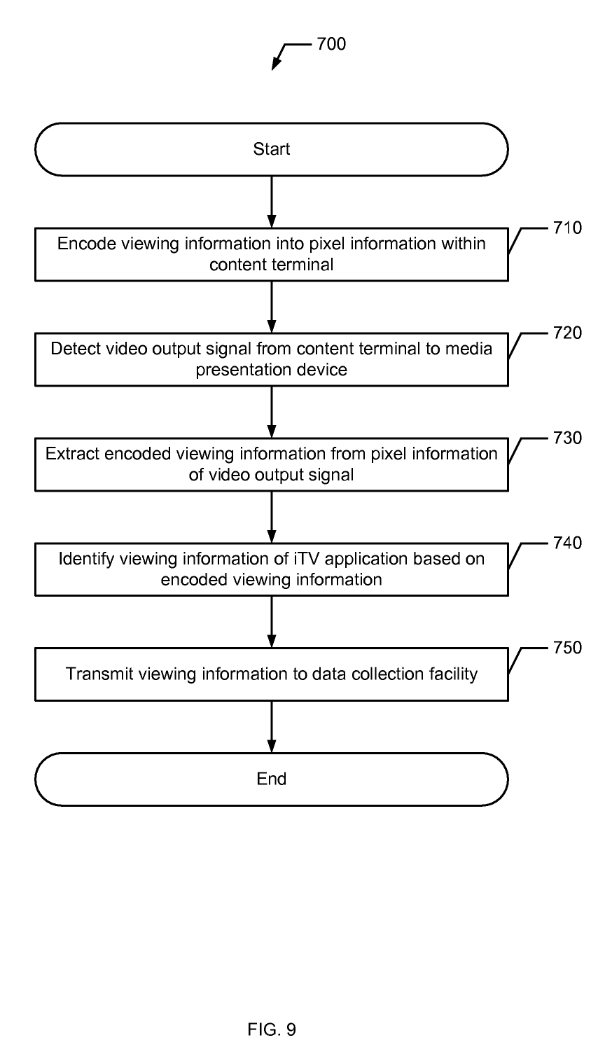

FIG. 9 is a flow diagram 700 depicting one manner in which the example video output monitoring system of FIG. 2 may be configured to identify viewing information. Persons of ordinary skill in the art will appreciate that the example process of FIG. 9 may be implemented as machine readable and executable instructions utilizing any of many different programming codes stored on any combination of machine-accessible media such as a volatile or nonvolatile memory or other mass storage device (e.g., a floppy disk, a CD, and a DVD). For example, the machine readable instructions may be embodied in a machine-accessible medium such as a programmable gate array, an application specific integrated circuit (ASIC), an erasable programmable read only memory (EPROM), a read only memory (ROM), a random access memory (RAM), a magnetic media, an optical media, and/or any other suitable type of medium. Further, although a particular order of actions is illustrated in FIG. 9, persons of ordinary skill in the art will appreciate that these actions can be performed in other temporal sequences. Again, the flow diagram 700 is merely provided and described in conjunction with the components of FIGS. 1-6 as an example of one way to program or configure a processor to identify viewing information based on video output signals.

In the example of FIG. 9, the process 700 begins with the content terminal 210 encoding viewing information into pixel information of a video output signal (block 710). As noted above, the content terminal 210 may encode the viewing information using an ASCII coding algorithm, a Huffman-based coding algorithm, a binary coding algorithm, and/or any other suitable coding algorithms to generate the encoded viewing information. The viewing information may be based on tuning and demographic information associated with the programming content 300 such as status associated with a household member, a channel, a tuned channel, and/or a timestamp associated with the tuned channel. The metering device 230 detects the video output signal from the content terminal 210 to the media presentation device 220 (block 720). In particular, the video output signal includes pixel information to generate one or more images associated with programming content (e.g., an iTV application) on the screen 225 of the media presentation device 220. The pixel information includes video information and the encoded viewing information. The metering device 230 extracts the encoded viewing information from the pixel information of the video output signal (block 730). Certain predetermined pixels may be designated to indicate or represent a status or tuning event identifier, a channel identifier, and/or a timestamp (i.e., the encoded viewing information). Based on the encoded viewing information, the metering device 230 identifies the viewing information associated with the programming content (block 740). In particular, the metering device 230 may use the viewing information index 400 to translate the encoded viewing information into viewing information. For example, the metering device 230 may identify a tuned channel, a status or a tuning event of a household member, and/or a time. Further, the metering device 230 transmits the viewing information to the data collection facility 180 via the network 170 (block 750). The data collection facility 180 may process to produce ratings data without having to use a return/back channel controlled by an iTV service provider.

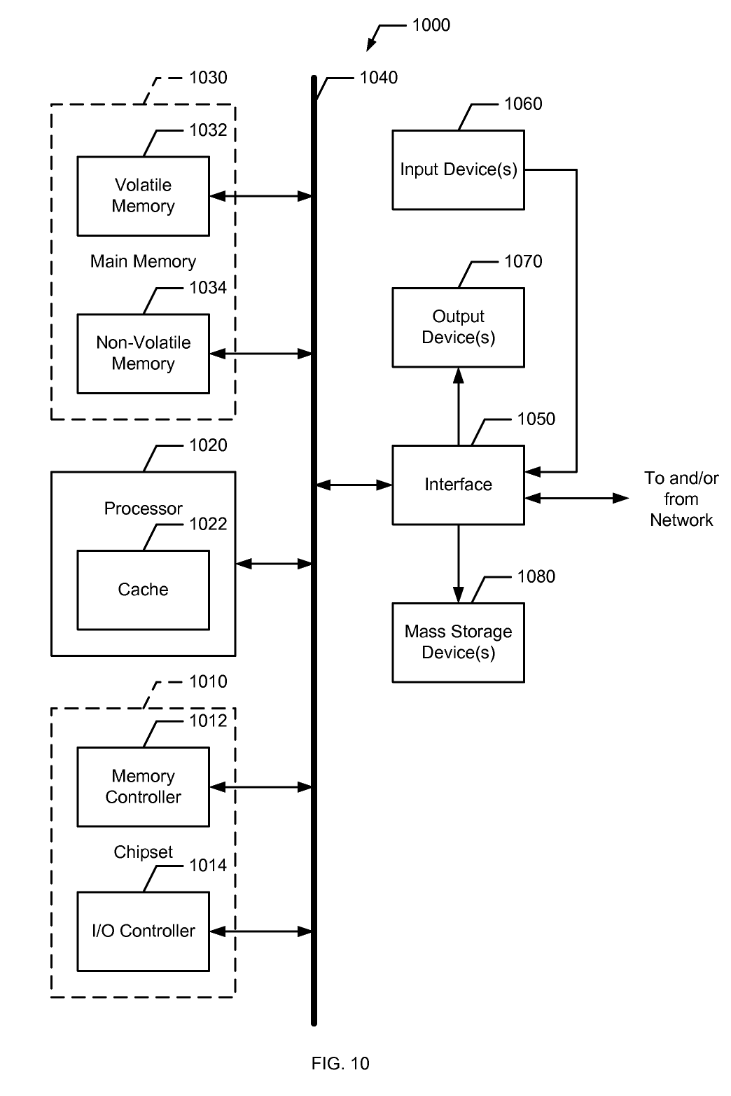

FIG. 10 is a block diagram of an example processor system 1000 adapted to implement the methods and apparatus disclosed herein. The processor system 1000 may be a desktop computer, a laptop computer, a notebook computer, a personal digital assistant (PDA), a server, an Internet appliance or any other type of computing device.

The processor system 1000 illustrated in FIG. 10 includes a chipset 1010, which includes a memory controller 1012 and an input/output (I/O) controller 1014. As is well known, a chipset typically provides memory and I/O management functions, as well as a plurality of general purpose and/or special purpose registers, timers, etc. that are accessible or used by a processor 1020. The processor 1020 is implemented using one or more processors. In the alternative, other processing technology may be used to implement the processor 1020. The processor 1020 includes a cache 1022, which may be implemented using a first-level unified cache (L1), a second-level unified cache (L2), a third-level unified cache (L3), and/or any other suitable structures to store data as persons of ordinary skill in the art will readily recognize.

As is conventional, the memory controller 1012 performs functions that enable the processor 1020 to access and communicate with a main memory 1030 including a volatile memory 1032 and a non-volatile memory 1034 via a bus 1040. The volatile memory 1032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 1034 may be implemented using flash memory, Read Only Memory (ROM), Electrically Erasable Programmable Read Only Memory (EEPROM), and/or any other desired type of memory device.

The processor system 1000 also includes an interface circuit 1050 that is coupled to the bus 1040. The interface circuit 1050 may be implemented using any type of well known interface standard such as an Ethernet interface, a universal serial bus (USB), a third generation input/output interface (3GIO) interface, and/or any other suitable type of interface.

One or more input devices 1060 are connected to the interface circuit 1050. The input device(s) 1060 permit a user to enter data and commands into the processor 1020. For example, the input device(s) 1060 may be implemented by a keyboard, a mouse, a touch-sensitive display, a track pad, a track ball, an isopoint, and/or a voice recognition system.

One or more output devices 1070 are also connected to the interface circuit 1050. For example, the output device(s) 1070 may be implemented by media presentation devices (e.g., a light emitting display (LED), a liquid crystal display (LCD), a cathode ray tube (CRT) display, a printer and/or speakers). The interface circuit 1050, thus, typically includes, among other things, a graphics driver card.

The processor system 1000 also includes one or more mass storage devices 1080 to store software and data. Examples of such mass storage device(s) 1080 include floppy disks and drives, hard disk drives, compact disks and drives, and digital versatile disks (DVD) and drives.

The interface circuit 1050 also includes a communication device such as a modem or a network interface card to facilitate exchange of data with external computers via a network. The communication link between the processor system 1000 and the network may be any type of network connection such as an Ethernet connection, a digital subscriber line (DSL), a telephone line, a cellular telephone system, a coaxial cable, etc.

Access to the input device(s) 1060, the output device(s) 1070, the mass storage device(s) 1080 and/or the network is typically controlled by the I/O controller 1014 in a conventional manner. In particular, the I/O controller 1014 performs functions that enable the processor 1020 to communicate with the input device(s) 1060, the output device(s) 1070, the mass storage device(s) 1080 and/or the network via the bus 1040 and the interface circuit 1050.

While the components shown in FIG. 10 are depicted as separate blocks within the processor system 1000, the functions performed by some of these blocks may be integrated within a single semiconductor circuit or may be implemented using two or more separate integrated circuits. For example, although the memory controller 1012 and the I/O controller 1014 are depicted as separate blocks within the chipset 1010, persons of ordinary skill in the art will readily appreciate that the memory controller 1012 and the I/O controller 1014 may be integrated within a single semiconductor circuit.

The methods and apparatus disclosed herein are particularly well suited for use with iTV applications. However, persons of ordinary skill in the art will appreciate that the teachings of the disclosure may be applied to identify viewing information associated with other applications including non-interactive applications such as television programs.

Although certain example methods, apparatus, and articles of manufacture have been described herein, the scope of coverage of this patent is not limited thereto. On the contrary, this patent covers all methods, apparatus, and articles of manufacture fairly falling within the scope of the appended claims either literally or under the doctrine of equivalents.

1. A method to identify viewing information, comprising:
detecting at least one media signal having pixel information to generate one or more images on a media presentation device;
extracting encoded viewing information generated at a media consumption site from the pixel information based on a pixel characteristic; and
identifying viewing information based on the encoded viewing information.

2. A method as defined in claim 1, wherein detecting the at least one media signal comprises detecting a media signal from one of a set top box or an interactive television terminal.

3. A method as defined in claim 1, wherein the pixel characteristic comprises at least one of color or intensity.

4. A method as defined in claim 1, wherein extracting the encoded viewing information comprises identifying information associated with one or more pixels.

5. A method as defined in claim 4, wherein the one or more pixels are arranged in at least one of a symmetrical configuration, an asymmetrical configuration, a contiguous configuration, or a non-contiguous configuration.

6. A method as defined in claim 4, wherein the one or more pixels are distributed on a screen of the media presentation device based on video content associated with the at least one media signal.

7. A method as defined in claim 6, wherein the one or more pixels are distributed in a first area of the screen for a first time duration and in a second area of the screen for a second time duration.

8. A method as defined in claim 1, wherein the encoded viewing information comprises one or more binary bits.

9. A method as defined in claim 8, wherein each of the one or more binary bits comprises at least one of a first binary value corresponding to a first pixel characteristic and a second binary value corresponding to a second pixel characterisitic.

10. A method as defined in claim 9, wherein the first binary value comprises a binary value of one, and wherein the second binary value comprises a binary value of zero.

11. A method as defined in claim 9, wherein the first pixel characteristic comprises a black pixel color, and wherein the second pixel characteristic comprises a non-black pixel color.

12. A method as defined in claim 1, wherein identifying the viewing information based on the encoded viewing information comprises identifying at least one of a status or an event of a household member, a tuned channel, and a time.

13. A method as defined in claim 1 further comprising transmitting the viewing information to a data collection facility.

14. A method as defined in claim 1 further comprising encoding the viewing information into the pixel information at the media consumption site to generate the encoded viewing information.

15. An apparatus to identify viewing information comprising:
a detecting device configured to detect at least one media signal having pixel information to generate one or more images on a media presentation device;
an extracting device coupled to the detecting device, the extracting device being configured to extract encoded viewing information generated at a media consumption site from the pixel information based on a pixel characteristic; and
an identifying device coupled to the extracting device, the identifying device being configured to identify viewing information based on the encoded viewing information.

16. An apparatus as defined in claim 15, wherein the at least one media signal comprises a media signal from at least one of a set top box or an interactive television terminal to a television.

17. An apparatus as defined in claim 15, wherein the pixel characteristic comprises at least one of color or intensity.

18. An apparatus as defined in claim 15, wherein the encoded viewing information comprises information associated with one or more pixels.

19. An apparatus as defined in claim 18, wherein the one or more pixels are distributed on a screen of the media presentation device based on video content associated with the at least one media signal.

20. An apparatus as defined in claim 19, wherein the one or more pixels are distributed in a first area of the screen for a first time duration and in a second area of the screen for a second time duration.

21. An apparatus as defined in claim 18, wherein the one or more pixels are arranged in at least one of a symmetrical configuration, an asymmetrical configuration, a contiguous configuration, or a non-contiguous configuration.

22. An apparatus as defined in claim 15, wherein the encoded viewing information comprises one or more binary bits.

23. An apparatus as defined in claim 22, wherein each of the one or more binary bits comprises at least one of a first binary value corresponding to a first pixel characteristic and a second binary value corresponding to a second pixel characteristic.

24. An apparatus as defined in claim 23, wherein the first binary value comprises a binary value of one, and wherein the second binary value comprises a binary value of zero.

25. An apparatus as defined in claim 23, wherein the first pixel characteristic comprises a black pixel color, and wherein the second pixel characteristic comprises a non-black pixel color.

26. An apparatus as defined in claim 15, wherein the viewing information comprises at least one of a status or an event of a household member, a tuned channel, or a time.

27. An apparatus as defined in claim 15 further comprising a memory coupled to the identifying device and configured to store the viewing information.

28. An apparatus as defined in claim 15 further comprising a communication interface coupled to the identifying device, the communication interface being configured to transmit the viewing information to a data collection facility.

29. A machine accessible medium storing instructions, which when executed, cause a machine to:
detect at least one media signal having pixel information to generate one or more images on a media presentation device;
extract encoded viewing information generated at a media consumption site from the pixel information based on a pixel characteristic; and
identify viewing information based on the encoded viewing information.

30-83. (canceled)
